(19) United States
(12) Patent Application Publication
(10) Pub. No.: US 2012/0079979 A1
(43) Pub. Date: Apr. 5, 2012

(54) Apparatus and methods for preventing entry of liquid into a cavity of a vehicle

(76) Inventor: Jorge Pinera, JR., Houston, TX (US)

(21) Appl. No.: 13/200,890

(22) Filed: Oct. 4, 2011

Related U.S. Application Data
(60) Provisional application No. 61/389,302, filed on Oct. 4, 2010.

(51) Int. Cl. B63B 17/00; B60J 10/00; B63H 11/00; B23P 11/00; B63B 35/73

(52) U.S. Cl. 114/363; 29/428; 277/628; 277/650; 277/630

(57) ABSTRACT

Apparatus and methods for preventing entry of liquids into a cavity of a vehicle or similar object can include a body configured for insertion into the cavity and a flap extending from the body for engaging an edge of the cavity. Engagement between the flap and cavity can form a seal that reduces or prevents the passage of liquid, while engagement of the body within the cavity can prevent movement of the apparatus in a manner that would permit disengagement of the flap, and can optionally form an additional seal. The apparatus and methods thereby function as lightweight, inexpensive alternatives to covers for the entire vehicle that can be readily installed and removed between uses.

### CROSS-REFERENCE TO RELATED APPLICATION

The present application claims priority under 35 U.S.C. §119(e) to the co-pending United States provisional application for patent, having the application Ser. No. 61/389,302, filed Oct. 4, 2010, the entirety of which is incorporated herein by reference.

### FIELD

Embodiments usable within the scope of the present disclosure relate, generally, to apparatus and methods for preventing the entry of liquid into a cavity of a vehicle, and more specifically, to bodies adapted for insertion into and/or covering of foot wells or similar cavities of a jet ski or other vehicle.

### BACKGROUND

Many recreational water vehicles, such as jet skis, include recessed regions (e.g., foot wells), where an operator's feet are placed during operations. Boats and other watercraft can also include various cavities and/or recessions usable for seating, standing, storage and/or securing of objects, and/or other aesthetic or utilitarian purposes. While it is often necessary for these cavities to remain uncovered during operation of these vehicles, many owners of such vehicles also leave these cavities uncovered during storage and other periods when the vehicles are not in use.

As such, the foot wells of a jet ski, and/or other similar cavities, remain exposed to the elements, and are often filled by rain or other water sources. The water then remains stagnant, allowing mold and algae to grow. When it is desired to use the vehicle, these wells and/or cavities must be emptied, typically using hoses and/or pumps; then, the mold, algae, mildew, and/or similar undesired growth and/or fouling must be removed through tedious cleansing, scraping, and scrubbing. Mold, algae, and/or other growth/fouling can often stain or corrode parts of a vehicle, such as the frictional surfaces that typically line the base of a jet ski's foot wells, requiring replacement of these or other parts. Aggressive cleansers or cleaning operations can also scratch, stain, and/or otherwise damage parts of a vehicle.

During the winter, or other extended periods of non-use, covers for jet skis and similar watercraft can be used to protect the vehicles; however, these covers are sizeable, and are intended to cover the entire vehicle. As such, covers for a watercraft are often costly, and can be difficult and/or tedious to place and remove. For this reason, an operator will typically refrain from using such a cover except during an extended period of non-use. Between routine uses, a jet ski is often placed on lifts, where the foot wells and/or similar cavities remain exposed to inclement weather. The lifts are, themselves, costly, and when the foot wells of a jet ski become filled with water, the lifts can be subjected to as much as 75 to 250 additional pounds of weight.

A need exists for apparatus and methods to prevent the accumulation of water, mold, algae, microbials, and similar growth and/or fouling within the foot wells of a jet ski, and/or within other cavities of a vehicle, that is inexpensive, effective, and efficient to install and uninstall between routine uses of the vehicle.

Embodiments usable within the scope of the present disclosure meet these needs.

### SUMMARY

Embodiments usable within the scope of the present disclosure can include apparatus and methods for preventing entry of liquid (e.g., water) into a cavity of a vehicle (e.g., a foot well of a jet ski). The apparatus can include a body with a lower portion configured for insertion into the cavity of the vehicle, with a flap that extends from the upper surface thereof, and that is configured to overlap the edge of the cavity. For example, the flap can encircle the perimeter of the body for forming a watertight seal about the entirety of the apparatus to prevent liquid from entering the cavity.

In use, the flap, which can be formed from a material generally impermeable to water (e.g., plastic, rubber, neoprene, latex, laminate, and/or other similar materials), can form a generally watertight seal about the edge of the cavity, such that the entry of water is prevented. In an embodiment, the flap can be formed from a flexible material (e.g., neoprene) that conforms to an exterior surface of the vehicle when placed thereon, thereby defining a fluid path that flows liquid away from the cavity.

The body can be formed from generally water impermeable and/or water resistant, lightweight materials, such as polystyrene, rubber, plastic, latex, laminate, and/or neoprene, a thermoformed material, or various similar polymers, co-polymers, composites, or other materials. In an embodiment, the body can be at least partially hollow to reduce the overall weight of the apparatus. Typically, the body can be sized to prevent movement of the body within the cavity a distance greater than the width of the flap, thus preventing removal of the flap from the edge of the cavity. However, in an embodiment, the body can occupy all or substantially all of the cavity, facilitating a tight and/or interference fit, which can both stabilize the apparatus within the cavity as well as facilitate a seal between the body and the cavity. In a further embodiment, the flap can protrude from the side of the body to create a generally watertight interference fit between the flap and an inner surface of the cavity when inserted.

In an embodiment, the apparatus can further include one or more handles for facilitating manual removal of the body from the cavity. Usable handles can include, without limitation, a “U” shaped handle, a “T” shaped handle, one or more protruding elements or panels, one or more knobs, a flexible rope or leash element, or other similar objects usable to receive a force for moving and/or transporting the apparatus. In a further embodiment, the handle can be adapted to fold and/or otherwise be inserted into a surface of the apparatus.

Thus, in use, placement of the body into a cavity of a vehicle, such that the flap overlaps an edge of the cavity, enables the flap to prevent entry of liquid into the cavity. The seal between the cavity can be generally watertight, and in an embodiment, can be airtight. The materials from which the body and/or the flap are formed can be water resistant and/or impermeable, and in an embodiment, can be resistant to microbial growth, growth of algae, mold, and/or fungus, and/or otherwise resistant to fouling.

Embodiments usable within the scope of the present disclosure thereby prevent entry of liquid into a cavity of a vehicle, providing an effective, lightweight, efficient, and inexpensive alternative to cumbersome covers and/or tedious pumping and cleaning operations.

### BRIEF DESCRIPTION OF THE DRAWINGS

In the detailed description of various embodiments usable within the scope of the present disclosure, presented below, reference is made to the accompanying drawings, in which:

FIG. 1 depicts an exploded perspective view of an embodiment of the present apparatus in use with a jet ski.

FIG. 2 depicts a top plan view of the apparatus and jet ski of FIG. 1.

FIG. 3 depicts a front cross-sectional view of the apparatus and jet ski of FIG. 2, taken along line 3-3.

One or more embodiments are described below with reference to the listed Figures.

### DETAILED DESCRIPTION OF THE EMBODIMENTS

Before describing selected embodiments of the present disclosure in detail, it is to be understood that the present invention is not limited to the particular embodiments described herein. The disclosure and description herein is illustrative and explanatory of one or more presently preferred embodiments and variations thereof, and it will be appreciated by those skilled in the art that various changes in the design, organization, order of operation, means of operation, equipment structures and location, methodology, and use of mechanical equivalents may be made without departing from the spirit of the invention.

As well, it should be understood that the drawings are intended to illustrate and plainly disclose presently preferred embodiments to one of skill in the art, but are not intended to be manufacturing level drawings or renditions of final products and may include simplified conceptual views as desired for easier and quicker understanding or explanation. As well, the relative size and arrangement of the components may differ from that shown and still operate within the spirit of the invention.

Moreover, it will be understood that various directions such as “upper”, “lower”, “bottom”, “top”, “left”, “right”, and so forth are made only with respect to explanation in conjunction with the drawings, and that the components may be oriented differently, for instance, during transportation and manufacturing as well as operation. Because many varying and different embodiments may be made within the scope of the concept(s) herein taught, and because many modifications may be made in the embodiments described herein, it is to be understood that the details herein are to be interpreted as illustrative and non-limiting.

As described previously, embodiments usable within the scope of the present disclosure generally relate to methods and apparatus (e.g., a foot well mold) having a body configured for insertion into a foot well or similar cavity of a jet ski or other vehicle, with a flap extending therefrom for sealing the cavity and preventing water and/or other environmental elements from entering the cavity.

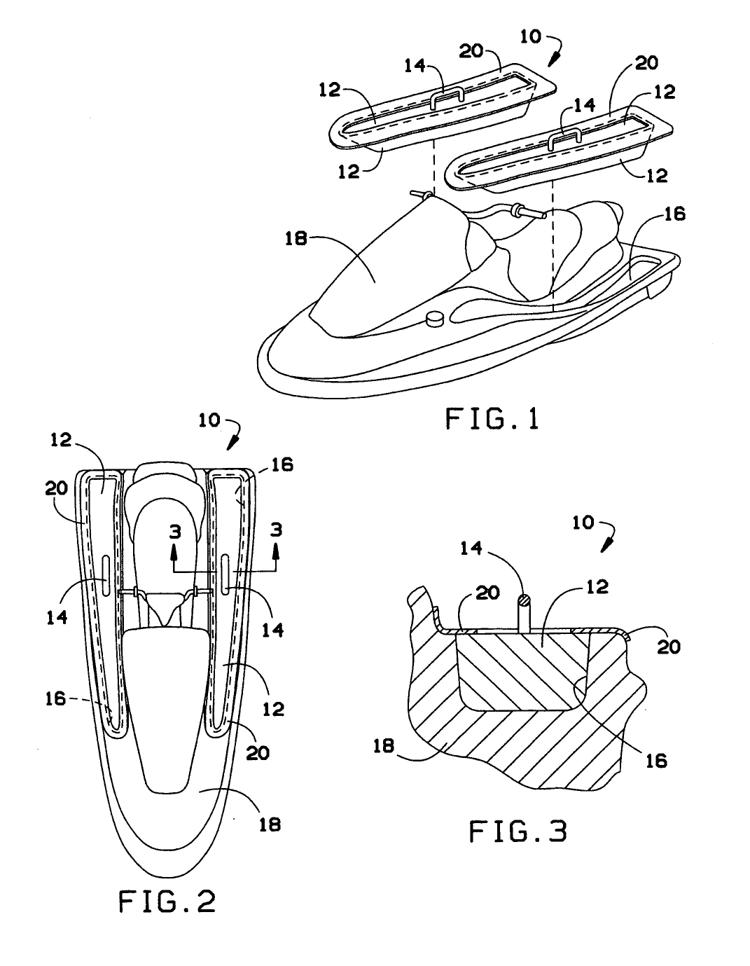

Referring now to FIG. 1, an exploded perspective view of an embodiment of the present apparatus (10) for use with a jet ski (18) is shown. It should be understood that while FIG. 1 depicts two apparatus (10) for use in association with two foot well cavities of a jet ski (18), embodiments usable within the scope of the present disclosure can be used in association with any recession, cavity, opening, and/or orifice within any vehicle or other object, to prevent the entry of external liquid therein. As such, the depicted jet ski (18) can be representative of any personal watercraft, vehicle, or other object, and is shown including a foot well or cavity (16) typically used by an operator to place his or her feet during operation, or for other stowage purposes. The cavity (16) can be representative of any surface and/or space that may collect water or other environmental elements.

The apparatus (10) is shown having a body (12), which can be molded and/or otherwise formed to fit, at least partially, within the cavity (16). For example, the body (12) can be a positive mold, while the cavity (16) defines a corresponding negative mold. The body (12) can be formed from open or closed cell foam, rubber, plastic, neoprene, latex, one or more polymers and/or laminates, one or more thermoformed materials, or combinations thereof, and in an embodiment, the body (12) can be at least partially hollow to reduce the weight thereof. The body (12) can further include any manner of skin, membrane, laminate, covering, coating and/or other surface treatment on all or a portion thereof to resist or prevent growth of algae and/or mold, damage from ultraviolet radiation, absorption of water into the body (12), and can promote a better seal between the body (12) and the cavity (16) of the jet ski (18) when installed therein.

While FIG. 1 depicts the body (12) sized to fit tightly into the cavity (16), occupying all or substantially all of the cavity, in various embodiments, the body (12) of the apparatus (10) can partially occupy the cavity (16) and leave a void (e.g., beneath the body (12)) for enabling objects to be stored within the cavity (16) during periods of non-use while protected from moisture and/or inclement weather by the apparatus (10). If the body (12) does not occupy the entirety of the cavity (16), typically, the body (12) can permit movement of the apparatus (10) a distance less than the width of the flap (20) shown thereon, such that the flap (20) remains in an overlapping relationship with the edge of the cavity (16) independent of the position of the body (12).

FIG. 1 depicts the flap (20) extending along the perimeter of the top surface of the body (12). The flap (20) can be integral with the body (12) or connected to the body (12) through any suitable means of attachment (e.g., watertight adhesive, stitching, Velcro™ or other fastening mediums). Specifically, the flap (20) is shown as a flat, flexible, watertight strip of material, such as latex, neoprene, plastic, laminate, rubber, and/or other polymers or elastomers. When the body (12) is inserted into the cavity (16), the flap (20) can extend over the edge of the cavity (16) and form a seal between the apparatus (10) and the cavity (16). In various embodiments, this seal can be a watertight and/or airtight seal.

While FIG. 1 depicts the flap (20) extending from the top surface of the body (12), in an alternate embodiment, the flap (20) can be affixed to a side of the body (12), such that insertion of the apparatus (10) into the cavity (16) causes at least partial compression of the flap (20) and/or an interference fit between the flap (20) and the inner surface of the cavity (16) to form a seal therebetween.

FIG. 1 further depicts the apparatus (10) having a handle (14) extending from an upper surface of the body (12). While FIG. 1 depicts the apparatus (10) having a single, “U” shaped handle (14), it should be understood that any number and any configuration of handles can be included, including “T” shaped handles, protruding elements or panels, knobs, flexible rope and/or leash elements, indentations within the body (12) suitable for gripping and/or pulling the apparatus (10), or other similar means for manually applying a force to the apparatus (10).

Referring now to FIG. 2, FIG. 2 depicts a top plan view of the apparatus (10) and jet ski (18) of FIG. 1. The jet ski (18) is shown having two cavities (16) (e.g., foot wells) into which two apparatus (10) are configured to be inserted. As shown, the bodies (12) of each apparatus (10) are placed into a respective cavity (16), such that the flaps (20) of the apparatus (10) extend over respective edges of the cavities (16) to prevent the entry of liquid therein, while handles (14) can be used to remove the bodies (12) from the cavities (16) when desired.

Referring now to FIG. 3, a front cross-sectional view of the apparatus (10) and jet ski (18) of FIG. 2 is shown, taken along line 3-3. The depicted body (12) is shown occupying substantially all of the cavity (16), preventing significant movement of the apparatus (10) once inserted therein. In an embodiment, the body (12) can form an interference fit with the cavity (16) and/or otherwise form a seal therewith to further prevent entry of any liquid and/or moisture that may bypass the flap (20). The flap (20) is shown extending from the upper surface of the body (12) in an overlapping relationship with the edge of the cavity (16), such that a seal can be formed therewith for preventing entry of water or other liquids.

FIG. 3 depicts the flap (20) formed from a flexible material, such as neoprene, various plastics, rubber, laminates, polymers, or other similar materials, such that the flap (20) conforms with the exterior surface of the jet ski (18). For example, in the configuration shown in FIG. 3, rain water or similar moisture that strikes the jet ski (18) will flow over the fluid path defined by the contours of the flap (20) and the upper surface of the body (12), in a left-to-right direction. The flap (20) thereby channels water away from the jet ski (18) and cavity (16) without permitting the water to collect thereon.

Embodiments usable within the scope of the present disclosure thereby include apparatus and methods for preventing entry of water and/or other liquids into a cavity of a vehicle (e.g., a foot well of a jet ski) and/or other recessions or spaces in other objects, thereby preventing the growth of mold, algae, and/or similar fouling that can corrode, stain, or damage various objects. Embodiments described herein can provide inexpensive, lightweight, efficient alternatives to traditional lifts and/or covers, that are easy to install and uninstall between routine uses of a jet ski or similar vehicle and/or object.

While various embodiments usable within the scope of the present disclosure have been described with emphasis, it should be understood that within the scope of the appended claims, the present invention can be practiced other than as specifically described herein.

What is claimed is:

1. An apparatus for preventing entry of liquid into a cavity of a vehicle, the apparatus comprising:
a body having a portion configured for insertion into the cavity; and
a flap extending from the body and configured to engage an edge of the cavity.

2. The apparatus of claim 1, further comprising a handle extending from the body, the flap, or combinations thereof, wherein the handle is adapted to facilitate manual removal or insertion of the body from the cavity.

3. The apparatus of claim 1, wherein the body is formed from polystyrene, rubber, plastic, neoprene, latex, laminate, or combinations thereof.

4. The apparatus of claim 1, wherein the body comprises a hollow member.

5. The apparatus of claim 1, wherein the flap comprises a material generally impermeable to water.

6. The apparatus of claim 1, wherein the flap comprises plastic, rubber, neoprene, latex, laminate, or combinations thereof.

7. The apparatus of claim 1, wherein the flap forms a watertight seal with the edge of the cavity.

8. The apparatus of claim 1, wherein the flap comprises a flexible material configured to conform to an exterior surface of the vehicle and define a fluid path for flowing liquid away from the cavity.

9. The apparatus of claim 1, wherein the body is sized to prevent movement of the body within the cavity a distance greater than a width of the flap.

10. The apparatus of claim 9, wherein the body is sized to occupy substantially all of the cavity.

11. A method for preventing entry of liquid into a cavity of a vehicle, the method comprising the step of placing a body into the cavity, wherein the body comprises a flap extending therefrom, such that the flap engages an edge of the cavity, and wherein the flap prevents entry of liquid into the cavity.

12. The method of claim 11, wherein the step of placing the body into the cavity comprises inserting a lower portion of the body into the cavity such that at least a portion of the cavity is occupied by the body.

13. The method of claim 12, wherein the step of inserting the lower portion of the body into the cavity prevents movement of the body within the cavity a distance greater than a width of the flap.

14. The method of claim 13, wherein the step of inserting the lower portion of the body into the cavity occupies substantially all of the cavity with the body.

15. The method of claim 11, wherein the step of placing the body into the cavity forms a watertight seal between the flap and the edge of the cavity.

16. The method of claim 11, wherein the step of placing the body into the cavity causes the flap to conform to an exterior surface of the vehicle, thereby defining a fluid path for flowing liquid away from the cavity.

17. The method of claim 11, further comprising the step of removing the body from the cavity by applying a force to a handle extending from the body.

18. A foot well mold for a jet ski, the foot well mold comprising:
a body having a top side, wherein the body is configured to fit within a cavity of the jet ski; and
a flap affixed to the top side of the body, wherein the flap is configured to run along a length of an edge of the top side and extend beyond the edge of the top side.

19. The foot well mold of claim 18, further comprising a handle affixed to the top side of the body.

20. The foot well mold of claim 18, wherein the flap comprises a flexible watertight material configured to conform to an exterior surface of the vehicle and define a fluid path for flowing liquid away from the cavity.
